(19) United States
(12) Patent Application Publication
(10) Pub. No.: US 2007/0046580 A1
(43) Pub. Date: Mar. 1, 2007

(54) Apparatus and method for driving plasma display panel

(76) Inventor: Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/490,424

(22) Filed: Jul. 19, 2006

(30) Foreign Application Priority Data
Aug. 27, 2005 (KR) 10-2005-0079121

(51) Int. Cl. G09G 3/28

(52) U.S. Cl. 345/68

(57) ABSTRACT

A plasma display panel driving apparatus and method for applying a driving voltage to drive a plasma display panel, where the plasma display panel includes discharge cells formed where the X electrodes cross the Y electrodes. The apparatus includes an X electrode driver for applying the driving voltages to the X electrodes and a Y electrode driver for applying the driving voltages to the Y electrodes. The X electrode driver comprises a first energy recovery unit collecting and accumulating charge from discharge cells and then providing the accumulated charge to the discharge cells, in the address period, and may also include a second energy recovery unit collecting and accumulating charge from the discharge cells and then providing the accumulated charge to the discharge cells, in the sustain-discharge period.

### CROSS-REFERENCE TO RELATED APPLICATIONS

This application claims the benefit of Korean Patent Application No. 10-2005-0079121, filed on Aug. 27, 2005, in the Korean Intellectual Property Office, the disclosure of which is incorporated herein in its entirety by reference.

### BACKGROUND

1. Field of the Invention

The present invention relates to an apparatus and method for driving a plasma display panel, and more particularly, to a plasma display panel driving apparatus including an energy recovery circuit for stably applying a quickly changing pulse-shaped voltage and a driving method thereof.

2. Description of Related Technology

Recently, in the field of large-sized flat-panel displays (FPDs), plasma display apparatuses including a plasma display panel (PDP) have come to public attention. In a plasma display apparatus, discharge gas is filled between two substrates of a plasma display panel, wherein a plurality of electrodes are formed on each substrate, discharge voltages are applied to the electrodes, vacuum ultraviolet radiation is generated by the discharge, and the vacuum ultraviolet radiation excites phosphor in a data driven pattern, thereby displaying images.

FIG. 1 is a block diagram of a driving apparatus for a conventional 3-electrode type plasma display panel 118.

Referring to FIG. 1, the conventional 3-electrode type plasma display panel driving apparatus includes an image processor 102, a logic controller 104, a common electrode driver 112, a scan electrode driver 114, and an address electrode driver 116. In the 3-electrode type plasma display panel 118, common electrodes C1 through Cn and scan electrodes S1 through Sn intersect address electrodes A1 through Am.

FIG. 2 is a view for explaining the structure of a discharge cell included in the plasma display panel 118 illustrated in FIG. 1.

Referring to FIG. 2, the conventional plasma display panel 118 includes a front substrate 202, a rear substrate 204, barrier ribs 206, phosphor layers 208, dielectric layers 209a and 209b, a protection layer 210, common electrodes 212, scan electrodes 214, and address electrodes 216.

In FIG. 2, a discharge cell is formed at an area surrounded by the barrier ribs 206 between a front panel and a rear panel. The front panel includes the front substrate 202, sustain-discharge electrode pairs consisting of the common electrodes 212 and the scan electrodes 214, the dielectric layers 209a, and the protection layer 210. The rear panel includes the rear substrate 204, the address electrodes 216, the dielectric layers 209b, the barrier ribs 206, and the phosphor layers 208.

FIG. 3 shows waveform diagrams of driving voltages applied to common electrodes, scan electrodes, and address electrodes to drive a 3-electrode type plasma display panel including discharge cells having the structure illustrated in FIG. 2.

In an address display separation (ADS) method, which is one of a plurality of plasma display panel driving methods, a unit frame is divided into a plurality of subfields SF and each subfield SF is divided into a reset period R, an address period A, and a sustain-discharge period S, so that driving voltages as illustrated in FIG. 3 are applied to respective electrodes, thereby displaying images on a plasma display panel. Referring to FIG. 3, in a reset period Pr, a ramp-shaped reset pulse voltage is applied to a scan electrode Sn. In an address period Pa, a scan pulse voltage is applied to the scan electrode Sn and an address pulse voltage is applied to an address electrode Am. In a sustain-discharge period Ps, a sustain pulse voltage is alternately applied to a common electrode Cn and the scan electrode Sn.

However, in the discharge cell structure of the plasma display panel illustrated in FIG. 2 driven by the driving voltages shown in FIG. 3, since visible rays generated when the phosphor layers are excited pass through the sustain-discharge electrode pairs 212 and 214, the dielectric layers 209a, the protection layer 210, etc. as well as the front substrate 202, the transmission rate of the visible rays with respect to the front panel is low. Also, since the sustain-discharge electrode pairs 212 and 214 are positioned in the upper parts of discharge cells, sustain-discharge occurring between the sustain-discharge electrode pairs 212 and 214 is concentrated in the upper parts of the discharge spaces of the discharge cells, resulting in lowering light-emitting efficiency. Furthermore, ion sputtering in which charged particles generated by discharge in the front panel side damage the phosphor layers 208 positioned in the rear panel side causes permanent afterimages.

In order to resolve these problems, an improved structure in which sustain-discharge electrode pairs are disposed in barrier ribs forming the lateral parts of discharge cells has been proposed.

A plasma display panel having such an improved structure may be a 3-electrode type plasma display panel or a 2-electrode type plasma display panel. The 2-electrode type plasma display panel has advantages over the 3-electrode type plasma display panel in terms of the following features. That is, in the 2-electrode type plasma display panel, since the number of electrodes and the number of required drivers are reduced compared to the 3-electrode type plasma display panel, manufacturing costs can be lowered. Also, since the 2-electrode type plasma display panel has a simple structure compared to the 3-electrode type plasma display panel, a driving method thereof can be simplified.

However, in order to drive the 2-electrode type plasma display panel, a plasma display panel driving method different from a driving method of the 3-electrode type plasma display panel is required.

In particular, a 2-electrode type plasma display panel driving method is needed to suppress heat generation when a quickly changing pulse-shaped voltages, such as an address pulse voltage or a sustain pulse voltage, are applied.

### SUMMARY OF CERTAIN INVENTIVE ASPECTS

The present invention provides an apparatus for driving a 2-electrode type plasma display panel, including an energy recovery circuit configured to stably apply a quickly changing pulse-shaped voltage, and a driving method thereof.

One embodiment is a plasma display panel driving apparatus configured to apply a driving voltage to a plasma display panel during a reset period, an address period, and a sustain-discharge period so as to drive the plasma display panel. The plasma display panel includes a plurality of X electrodes extending in a first direction, a plurality of Y electrodes extending in a second direction perpendicular to the first direction, and discharge cells formed near locations where the X electrodes cross the Y electrodes. The apparatus includes an X electrode driver configured to apply the driving voltage to the X electrodes, a Y electrode driver configured to apply the driving voltage to the Y electrodes, where the X electrode driver includes an address pulse voltage supplying unit configured to supply an address pulse voltage to the X electrodes to select discharge cells to be displayed during the address period, a first energy recovery unit configured to collect and store charge from discharge cells and to then provide the stored charge to the discharge cells, during the address period, an X electrode sustain pulse voltage supplying unit configured to supply an X electrode sustain pulse voltage to the X electrodes in order to sustain-discharge selected discharge cells, during the sustain discharge period, and a second energy recovery unit configured to collect and store charge from the discharge cells and to then provide the stored charge to the discharge cells, in the sustain-discharge period.

Another embodiment is a method of driving a plasma display panel, the plasma display panel including a plurality of X electrodes extending in a first direction, a plurality of Y electrodes extending in a second direction perpendicular to the first direction, and discharge cells formed near locations where the X electrodes cross the Y electrodes. The method includes applying an address pulse voltage having a positive pulse-shaped waveform to the X electrodes and applying a scan pulse voltage with a negative pulse-shaped waveform to the Y electrodes, where discharge cells are selected to be displayed, and applying an X electrode sustain pulse voltage alternately having a sustain-discharge voltage required for sustain-discharging and a ground voltage to the X electrodes, and applying a Y electrode sustain pulse voltage alternately having the ground voltage and the sustain-discharge voltage to the Y electrodes such that the Y electrode sustain pulse voltage has a polarity opposite of the X electrode sustain pulse voltage, where the selected discharge cells are sustain-discharged.

Another embodiment is a plasma display panel driving apparatus configured to apply a driving voltage to a plasma display panel during a reset period, an address period, and a sustain-discharge period so as to drive the plasma display panel, the plasma display panel including a plurality of X electrodes extending in a first direction, a plurality of Y electrodes extending in a second direction perpendicular to the first direction, and discharge cells formed near locations where the X electrodes cross the Y electrodes. The apparatus includes an X electrode driver configured to apply the driving voltage to the X electrodes, a Y electrode driver configured to apply the driving voltage to the Y electrodes, where the X electrode driver includes an address pulse voltage supplying unit configured to supply an address pulse voltage to the X electrodes to select discharge cells to be displayed during the address period, and a first energy recovery unit configured to collect and store charge from discharge cells and to then provide the stored charge to the discharge cells, during the address period.

### BRIEF DESCRIPTION OF THE DRAWINGS

The above and other features and advantages will become more apparent by describing in detail exemplary embodiments with reference to the attached drawings in which:

FIG. 1 is a block diagram of a driving apparatus of a conventional 3-electrode type plasma display panel;

FIG. 2 is a cross-sectional view of a discharge cell included in the 3-electrode type plasma display panel illustrated in FIG. 1;

FIG. 3 illustrates waveform diagrams of driving voltages applied to common electrodes, scan electrodes, and address electrodes to drive the 3-electrode type plasma display panel including discharge cells having the structure illustrated in FIG. 2;

FIG. 4 is a block diagram of a driving apparatus of a 2-electrode type plasma display panel according to an embodiment;

FIG. 5 is a cross-sectional view illustrating a discharge cell of a 2-electrode type plasma display panel, according to an embodiment;

FIGS. 6A and 6B illustrate shapes of discharge cells and discharge electrodes surrounding the discharge cells in a 2-electrode type plasma display panel;

FIGS. 7A and 7B are perspective views illustrating the arrangements of X electrodes and Y electrodes surrounding the discharge cells in a 2-electrode type plasma display panel;

FIG. 8 illustrates waveform diagrams of driving voltages applied to electrodes of a 2-electrode type plasma display panel, according to the conventional art;

FIG. 9 illustrates waveform diagrams of driving voltages applied to respective electrodes of a 2-electrode type plasma display panel;

FIG. 10 is a schematic view illustrating a configuration in which a 3-electrode type plasma display panel driving apparatus applies driving voltages to the respective electrodes of discharge cells through respective electrode drivers;

FIG. 11 is a schematic view for illustrating a configuration in which a 2-electrode type plasma display panel driving apparatus applies a sustain-pulse voltage to X electrodes of discharge cells through an X electrode driver including an energy recovery circuit;

FIGS. 12A, 12B, and 12C are graphs plotting driving voltages applied to X electrodes with an X electrode driver;

FIG. 13 is a circuit diagram of an X electrode driver of the 2-electrode type plasma display panel driving apparatus; and

FIG. 14 is a circuit diagram of a Y electrode driver of the 2-electrode type plasma display panel driving apparatus.

### DETAILED DESCRIPTION OF EMBODIMENTS

Certain embodiments will now be described more fully with reference to the accompanying drawings, in which embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their descriptions will not be repeated.

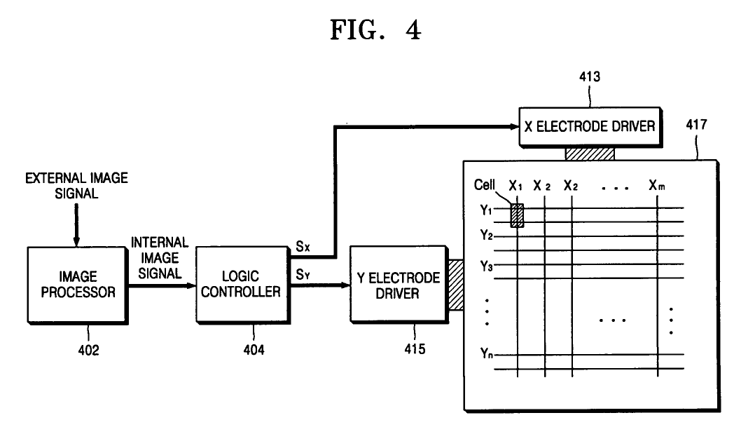

FIG. 4 is a block diagram of a driving apparatus of a 2-electrode type plasma display panel 417 according to an embodiment of the present invention.

Referring to FIG. 4, the 2-electrode type plasma display panel driving apparatus includes an image processor 402, a logic controller 404, an X electrode driver 413, and a Y electrode driver 415. In the 2-electrode type plasma display panel 417 illustrated in FIG. 4, X electrodes X₁ through Xₘ intersect Y electrodes Y₁ through Yₙ.

The image processor 402 receives image signals, such as PC signals, DVD signals, video signals, TV signals, etc., from an external source, converts the image signals into digital signals, performs image processing on the converted digital signals to generate internal image signals, and then transfers the image signals to the logic controller 404. The image signals include red (R) image data signals, green (G) image data signals, blue (B) image data signals, a clock signal, a vertical synchronization signal, a horizontal synchronization signal, etc.

In the 2-electrode type plasma display panel driving apparatus, the logic controller 404 performs gamma correction, Automatic Power Control (APC), etc. on the internal image signals transferred from the image processor 402, and generates an X electrode driver control signal Sₓ and a Y electrode driver control signal S_{Y}. The X electrode driver control signal Sₓ and the Y electrode driver control signal S_{Y} are respectively transferred to the X electrode driver 413 and the Y electrode driver 415.

In the 2-electrode type plasma display panel driving apparatus, the X electrode driver 413 receives the X electrode driver control signal S_{X} from the logic controller 404 and outputs an X electrode driver driving signal so that an X electrode driving voltage is applied to X electrodes X₁ through Xₘ of the plasma display panel. The Y electrode driver 415 receives the Y electrode driver control signal S_{Y} from the logic controller 404 and outputs a Y electrode driver driving signal so that a Y electrode driving voltage is applied to Y electrodes Y₁ through Yₙ of the plasma display panel.

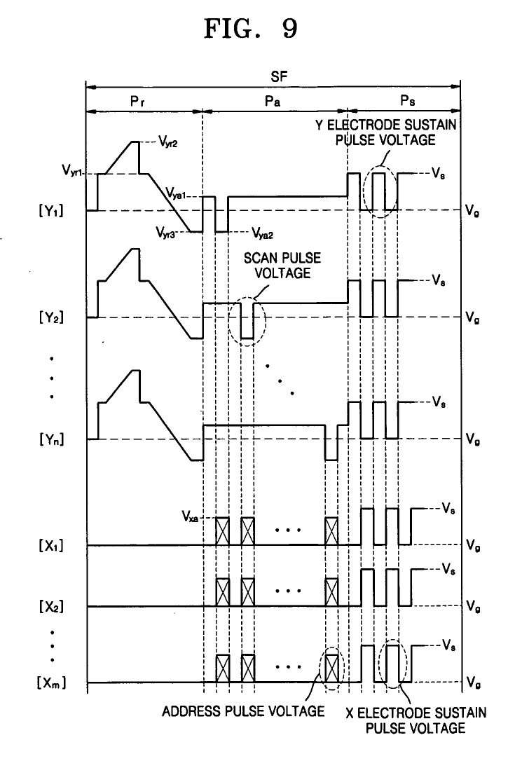

In the 2-electrode type plasma display panel 417 in which the X electrodes X₁ through Xₘ intersect the Y electrodes Y₁ through Yₙ as illustrated in FIG. 4, by applying the X electrode driving voltage and the Y electrode driving voltage to the respective electrodes X₁ through Xₘ and Y₁ through Yₙ so that discharge cells emit visible rays, an image corresponding to image signals input to the plasma display apparatus is displayed. Driving voltages applied to the respective electrodes X₁ through Xₘ and Y₁ through Yₙ of the 2-electrode type plasma display panel will be described later with reference to FIG. 9.

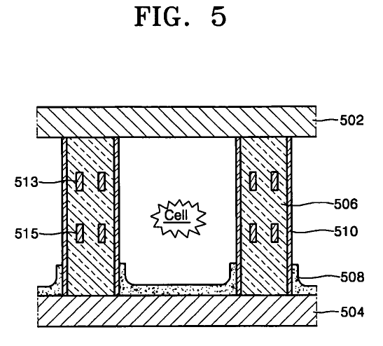

FIG. 5 is a view illustrating the structure of a discharge cell of a 2-electrode type plasma display panel, according to an embodiment of the present invention.

Referring to FIG. 5, the 2-electrode type plasma display panel includes a front substrate 502, a rear substrate 504, barrier ribs 506, phosphor layers 508, protection layers 510, X electrodes 513, and Y electrodes 515.

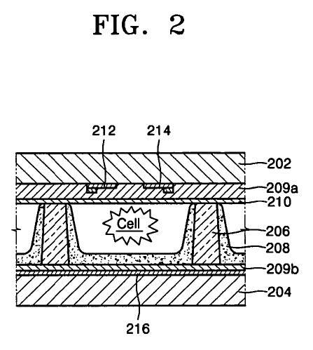

In the 2-electrode type plasma display panel having the structure described above, driving voltages are applied to discharge spaces of discharge cells through two type electrodes of the X electrodes 513 and the Y electrodes 515. That is, the X electrodes 513 and the Y electrodes 515 of the 2-electrode type plasma display panel structure act as common electrodes 212, scan electrodes 214, and address electrodes 216 of a 3-electrode type plasma display panel structure illustrated in FIG. 2.

A space between the front substrate 502 and the rear substrate 504 is partitioned by the barrier ribs 506, thus forming discharge cells which are unit discharge spaces. Each discharge cell has a front part (front substrate side), a rear part (rear substrate side), and lateral parts (barrier rib sides).

Since discharge gas having a pressure (approximately, 0.5 atm) lower than an atmospheric pressure is filled in the internal space of the discharge cell, charges collide with discharge gas particles when an electric field is formed according to driving voltages applied to the respective electrodes of the discharge cell and thus a plasma discharge is generated, so that vacuum ultraviolet radiation is generated by the plasma discharge. The discharge gas may be a mixture of Xe gas and at least one of Ne gas, He gas, and Ar gas.

The barrier ribs 506 define discharge cells which are basic units forming an image and prevent cross talk between the discharge cells.

The barrier ribs 506 can be formed to contain dielectrics. The dielectrics are used as insulation films of the X electrodes 513 and the Y electrodes 515, are disposed on the barrier ribs 506, and have high insulation resistance. Some of the charge generated by the discharge is attracted by an electric power according to the polarities of driving voltages applied to the respective electrodes and is accumulated near the dielectrics to thus form wall charges, so that a wall charge voltage formed by the wall charges is summed with the driving voltages applied to the respective electrodes, thus providing electric fields in the discharge spaces.

Also, the barrier ribs 506 can include dielectric layers used as insulation films of the X and Y electrodes 513 and 515. That is, in the 2-electrode type plasma display panel, the barrier ribs 506 can be formed with dielectrics or include separate dielectric layers.

In the phosphor layers 508, a photo luminescence mechanism in which vacuum ultraviolet (VUV) radiation generated by the discharge is absorbed and electrons excited by the VUV radiation emit visible rays when reaching a stable state, is performed. In order to display a color image on the plasma display panel, the phosphor layers 508 can include red-emitting phosphor layers, green-emitting phosphor layers and blue-emitting phosphor layers, wherein a red-emitting phosphor layer, a green-emitting phosphor layer, and a blue-emitting phosphor layer are positioned in proximal discharge cells to form a unit pixel. The red-emitting phosphor may be (Y,Gd)BO₃:EU₃⁺, the green-emitting phosphor may be Zn₂SiO₄:Mn₂⁺, and the blue-emitting phosphor may be BaMgAl₁₀O₁₇:Eu₂⁺.

The protection layer 510 protects the dielectrics or the dielectric layers and accelerates secondary electrons when discharge occurs, thereby facilitating the discharge. The protection layer 510 is formed of a material such as MgO.

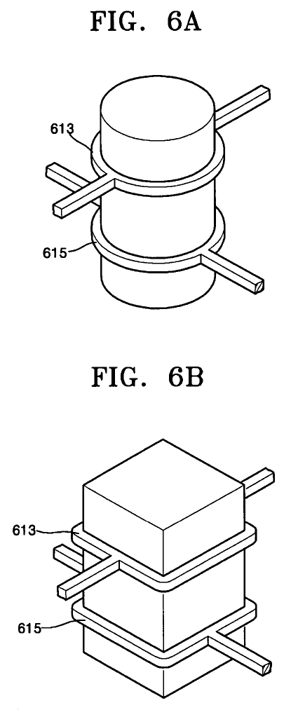

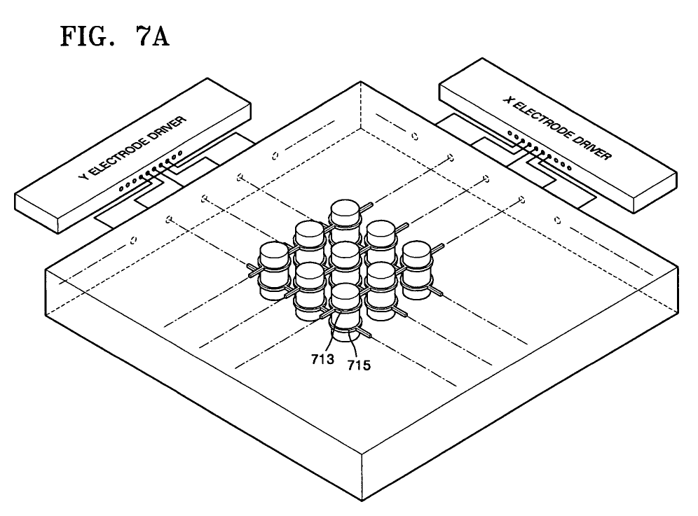

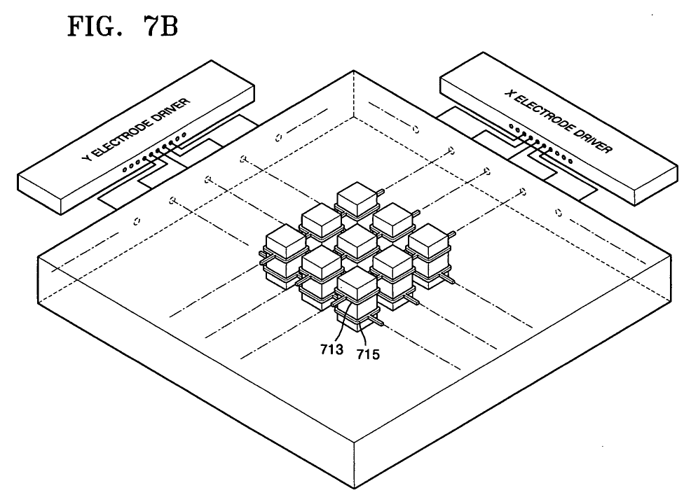

In the 2-electrode type plasma display panel according to one embodiment, the cross-section of a discharge cell resulting by cutting the discharge cell parallel to a front or rear substrate and perpendicular to lateral parts (that is, to barrier ribs) of the discharge cell may be a circle, or a polygon, such as a square, a hexagon, an octagon, etc. A structure in which the cross-section of a discharge cell is a circle is illustrated in FIGS. 6A and 7A, and a structure in which the cross-section of a discharge cell is a square is illustrated in FIGS. 6B and 7B.

When a discharge cell has a circular cross-section, the discharge cell has a cylindrical structure (see FIGS. 6A and 7A), and when a discharge cell has a square cross section, the discharge cell has a rectangular parallelepiped structure (see FIGS. 6B and 7B). The cylindrical structure is effective in view of discharge efficiency because it can efficiently use discharge spaces better than the rectangular parallelepiped structure.

FIGS. 6A and 6B illustrate the shapes of discharge cells and discharge electrodes surrounding the discharge cells in a 2-electrode type plasma display panel.

Each discharge cell may have a substantially cylindrical structure as illustrated in FIG. 6A or may have a substantially rectangular parallelepiped structure as illustrated in FIG. 6B. The cross-sectional shape of each discharge cell depends on a pattern of barrier ribs which partition a space between a front substrate and a rear substrate. The barrier ribs can be formed in various patterns considering light-emitting efficiency, manufacturing cost, etc.

In FIGS. 6A and 6B, an X electrode 613 surrounds the lateral part of a discharge cell parallel to the front part (front substrate side) and the rear part (rear substrate side) of the discharge cell, and a Y electrode 615 also surrounds the lateral part of the discharge cell parallel to the front and rear parts of the discharge cell like the X electrode 613.

FIGS. 7A and 7B are views illustrating the arrangement of X electrodes 713 and Y electrodes 715 surrounding the lateral parts of discharge cells according to embodiments of the present invention.

In FIG. 7A illustrating a cylindrical discharge cell structure and FIG. 7B showing a rectangular parallelepiped discharge cell structure, a plurality of X electrodes 713 are arranged parallel to the front and rear parts of the discharge cells while surrounding the lateral parts of the discharge cells, that is, parallel to a front substrate and a rear substrate. The X electrodes (corresponding to the X electrodes X₁, X₂, . . . , Xₘ of FIG. 4) 713 are connected to a X electrode driver through connection terminals.

Referring to FIGS. 7A and 7B, a plurality of Y electrodes 715 are arranged parallel to the front and rear parts of the discharge cells while surrounding the lateral parts of the discharge cells, and are generally perpendicular to the X electrodes 713. The Y electrodes (corresponding to the Y electrodes Y₁, Y₂, . . . , Yₙ of FIG. 4) 715 are connected to a Y electrode driver through connection terminals.

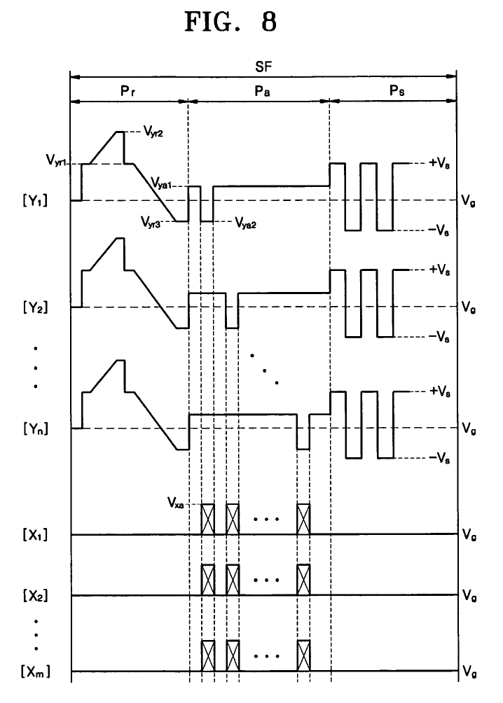

FIG. 8 illustrates waveforms of driving voltages applied to electrodes of a 2-electrode type plasma display panel.

As illustrated in FIG. 8, a subfield SF includes a rest period Pᵣ, an address period Pₐ, and a sustain-discharge period Pₛ.

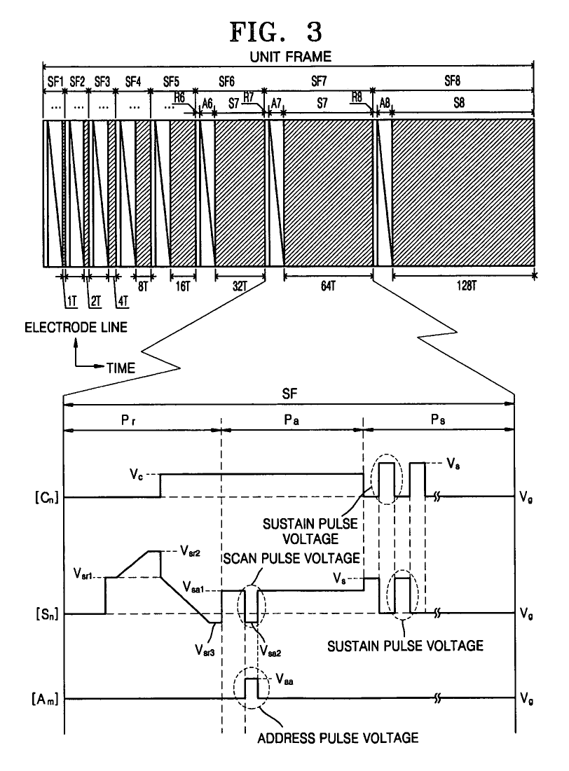

Since driving voltages are applied to discharge cells through 3 type electrodes in a 3-electrode type plasma display panel while driving voltages are applied to discharge cells through 2 type electrodes in a 2-electrode type plasma display panel, the driving voltage waveforms of FIG. 8 are different from the driving voltage waveforms of FIG. 3.

As seen in FIG. 8, during reset period Pᵣ, a ramp-shaped reset pulse voltage having a rising ramp-shaped voltage rising from V_{yr1} to V_{yr2} and a falling ramp-shaped voltage falling from V_{yr1} to V_{yr3} is applied to Y electrodes Y₁ through Yₙ, and a ground voltage V_{g} is applied to X electrodes X₁ through Xₘ, so that all discharge cells are initialized.

In an address period Pₐ, a scan pulse voltage (the scan pulse voltage is maintained at V_{ya1} after falling from V_{ya1} to V_{ya2}) with a negative pulse waveform is applied to the Y electrodes Y₁ through Yₙ, and an address pulse voltage (the address pulse voltage is maintained at V_{g} after rising from V_{g} to Vₓₐ) with a positive pulse waveform is applied to the X electrodes X₁ through Xₘ, so that discharge cells to be sustain-discharged in a following sustain-discharge period Pₛ are selected.

In the sustain-discharge period Pₛ, a positive sustain-discharge voltage +Vₛ and a negative sustain-discharge voltage −Vₛ are alternately applied to the Y electrodes Y₁ through Yₙ, wherein the ground voltage V_{g} can be applied during a predetermined period between +Vₛ and −Vₛ, and the ground voltage V_{g} is applied to the X electrodes X₁ through Xₘ, so that the discharge cells selected in the address period Pₐ are sustain-discharged.

FIG. 9 illustrates waveform diagrams of driving voltages applied to respective electrodes of a 2-electrode type plasma display panel according to one embodiment.

Comparing FIG. 9 with FIG. 8, driving voltage waveforms applied to the X electrodes X₁ through Xₘ and the Y electrodes Y₁ through Yₙ in the sustain-discharge period Pₛ are different from each other.

Referring to FIG. 9, in a reset period Pᵣ, the ground voltage V_{g} is applied to the X electrodes X₁ through Xₘ, and a ramp-shaped reset pulse voltage is applied to the Y electrodes Y₁ through Yₙ, so that the states of all discharge cells are initialized. The ramp-shaped reset pulse voltage has a rising ramp-shaped voltage rising from a first Y electrode reset voltage Y_{yr1} higher than the ground voltage V_{g} to a second Y electrode reset voltage V_{yr2} higher than the first Y electrode reset voltage V_{yr1}, and a falling ramp-shaped voltage falling from the first Y electrode reset voltage V_{yr1} to a third Y electrode reset voltage V_{yr3} lower than the first Y electrode reset voltage V_{yr1}.

In the reset period Pᵣ, by equalizing the first Y electrode reset voltage V_{yr1} to a sustain discharge voltage Vₛ, the number of drivers required for driving a plasma display panel can be reduced.

In the address period Pₐ, an address pulse voltage with a positive pulse waveform is applied to the X electrodes X₁ through Xₘ and a scan pulse voltage with a negative pulse waveform is applied to the Y electrodes Y₁ through Yₙ, according to control signals corresponding to external image signals input to a plasma display apparatus, so that discharge cells to be displayed are selected.

In the address period Pₐ, the address pulse voltage becomes the ground voltage V_{g} and the X electrode address voltage Vₓₐ with predetermined intervals, as illustrated in FIG. 9.

In the address period Pₐ, the scan pulse voltage becomes the first Y electrode address voltage V_{ya1} and the second Y electrode address voltage V_{ya2} with predetermined intervals, as illustrated in FIG. 9.

In the address period Pₐ, the first Y electrode address voltage V_{ya1} can be greater than or equal to the ground voltage V_{g}.

In the sustain-discharge period Pₛ, an X electrode sustain pulse voltage alternately having the sustain-discharge voltage Vₛ causing sustain-discharge and the ground voltage V_{g} is applied to the X electrodes X₁ through Xₘ, and a Y electrode sustain-pulse voltage alternately having the ground voltage V_{g} and the sustain discharge voltage Vₛ is applied to the Y electrodes Y₁ through Yₙ, according to control signals corresponding to external image signals input to the plasma display apparatus, wherein the X electrode sustain pulse voltage has a polarity opposite to the Y electrode sustain pulse voltage, so that discharge cells selected in the address period Pₐ are sustain-discharged.

When the driving voltages with the waveforms are applied to the X electrodes X₁ through Xₘ and the Y electrodes Y₁ through Yₙ to drive the 2-electrode type plasma display panel, the address pulse voltages applied in the address period Pₐ and the sustain pulse voltages (X electrode sustain pulse voltage and the Y electrode sustain pulse voltage) applied in the sustain-discharge period Pₛ are quickly changing pulse-shaped voltages. Also, the address pulse voltages and the sustain pulse voltages are frequently applied in response to image signals input from an external source to the plasma display apparatus.

As such, frequently applying the quickly changing pulse-shaped voltages to the respective electrodes can put a large burden on switching devices which have high power consumption. Accordingly, when the quickly changing pulse-shaped voltages are applied to the respective electrodes through the switching devices, power consumption of the switching devices needs to be reduced.

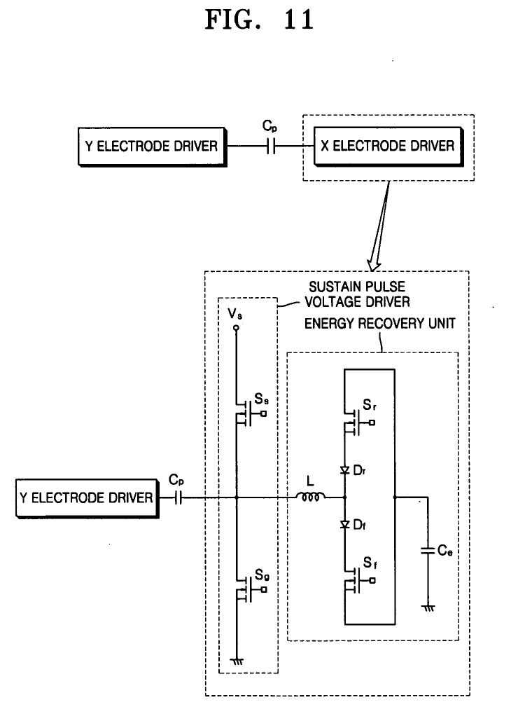

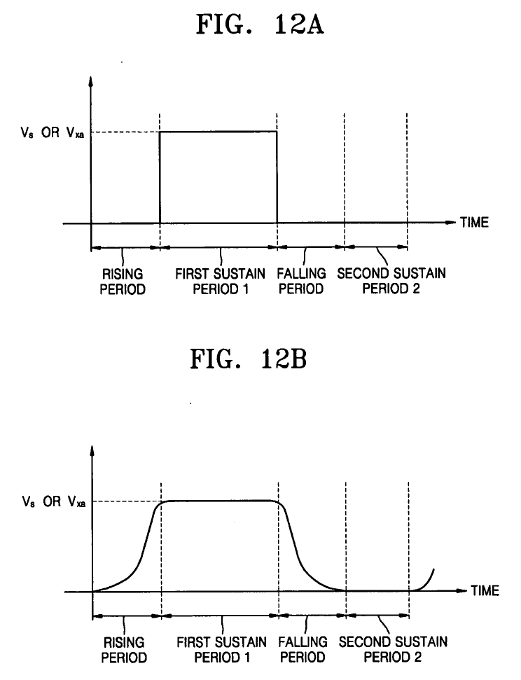

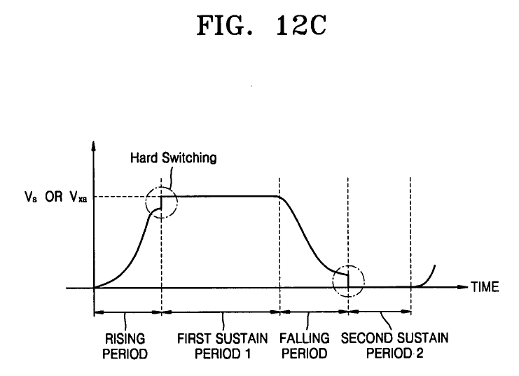

In order to reduce the power consumption of the switching devices, an energy recovery circuit (ERC) for reducing consumption power using LC resonance between a resonance inductor and a panel capacitor is used. The ERC will be described in detail later with reference to FIGS. 11, 12A, 12B, and 12C.

In the address period Pₐ, since the scan pulse voltage applied to the Y electrodes Y₁ through Yₙ quickly changes but is not frequently applied, the above problem is not significant.

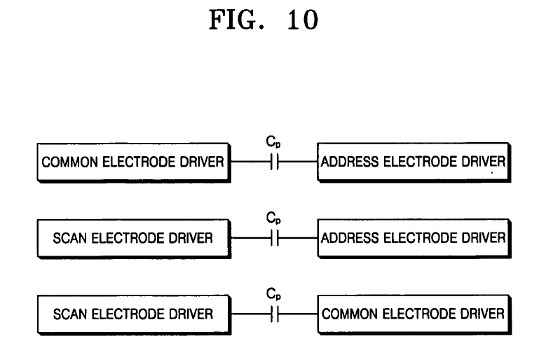

FIG. 10 is a schematic view illustrating a configuration in which a driving apparatus of a 3-electrode type plasma display panel applies driving voltages to the respective electrodes of discharge cells through respective electrode drivers. The scan pulse voltage applied in the address period Pₐ could also be a pulse-shaped voltage.

Referring to FIG. 10, a panel capacitance is formed in the discharge cells of the plasma display panel due to parasitic capacitances between the X and Y electrodes. Accordingly, the discharge cells can be equivalently modeled by the panel capacitance and a panel capacitance of electrodes surrounding the discharge cells. Capacitors Cₚ illustrated in FIG. 10 represent panel capacitors Cₚ.

The discharge cells of the 3-electrode type plasma display panel include common electrodes, scan electrodes, and address electrodes. By applying driving voltages, discharge is generated between the common electrodes and the address electrodes, between the scan electrodes and the address electrodes, and between the scan electrodes and the common electrodes.

In the upper part of FIG. 10, in order to explain discharge between the common electrodes and the address electrodes, a common electrode driver for applying a driving voltage to the common electrodes, an address electrode driver for applying a driving voltage to the address electrodes, and a panel capacitor Cₚ by which the discharge cells are equivalently modeled, are illustrated.

In the middle part of FIG. 10, in order to explain discharge between the scan electrodes and the address electrodes, a scan electrode driver for applying a driving voltage to the scan electrodes, an address electrode driver for applying a driving voltage to the address electrodes, and a panel capacitor Cₚ, are illustrated.

In the lower part of FIG. 10, in order to explain discharge between the scan electrodes and the common electrodes, a scan electrode driver for applying a driving voltage to the scan electrodes, a common electrode driver for applying a driving voltage to the common electrodes, and a panel capacitor Cₚ, are illustrated.

FIG. 11 is a view for explaining an operation in which a driving apparatus of a 2-electrode type plasma display panel applies a sustain-pulse voltage to X electrodes of discharge cells through an X electrode driver including an energy recovery circuit, according to an embodiment of the present invention. FIGS. 12A, 12B, and 12C are graphs showing pulse-shaped driving voltages applied to the X electrodes through the X electrode driver.

The discharge cells of the 2-electrode type plasma display panel include X electrodes and Y electrodes. As shown in the upper part of FIG. 11, the X electrode driver and the Y electrode driver apply corresponding driving voltages to the X electrodes and Y electrodes, respectively. Thus, discharge is generated between the X electrodes and the Y electrodes in the discharge cells equivalently modeled to the panel capacitor Cₚ.

In the lower part of FIG. 11, a driving circuit including an energy recovery unit (energy recovery circuit) and a sustain pulse voltage supply unit for applying a sustain pulse voltage is illustrated. The X electrode driver includes a plurality of driving circuits in order to drive a plurality of X electrodes (that is, the X electrodes X₁, X₂, . . . , Xₘ of FIG. 4) disposed on the plasma display panel.

The X electrode sustain pulse voltage applied in the sustain-discharge period Pₛ shown in FIG. 9 is a square pulse-shaped voltage discontinuously changing as illustrated in FIG. 12a. However, the X electrode sustain pulse voltage may be a pulse-shaped voltage continuously changing as illustrated in FIG. 12B. The Y electrode sustain pulse voltage in the sustain-discharge period Pₛ and the address pulse voltage in the address period Pₐ may also be pulse-shaped voltages continuously changing. However, the scan pulse voltage applied in the address period Pₐ is not considered because it is not frequently applied. scan pulse voltage applied in the address period Pₐ could also be a pulse-shaped voltage.

Hereinafter, when the X electrode sustain pulse voltage, the Y electrode sustain pulse voltage, and the address pulse voltage are applied, a method of reducing power consumption using an energy recovery circuit will be described.

When a square pulse-shaped voltage discontinuously changing between a first voltage (for example, the sustain-discharge voltage Vₛ or the X electrode address voltage Vₓₐ) and a second voltage (for example, the ground voltage V_{g}) is applied to respective electrodes (see FIG. 12A), charge accumulated in a panel capacitor Cₚ flows to a ground terminal when a driving voltage is applied in the previous period, resulting in greatly increasing power consumption. In order to allow a switching device to apply a discontinuous voltage to the respective electrodes, the switching device should operate under ‘hard switching’. However, if the ‘hard switching’ is frequently performed, the switching device may be damaged.

In order to resolve the problem, a webber type energy recovery circuit (ERC) including a charge capacitor and a resonance inductor is used (see FIG. 11). The webber type energy recovery circuit (ERC) accumulates charge accumulated in the panel capacitor Cₚ when a driving voltage is applied in the previous period in the charge capacitor, and uses the charge when a driving voltage is applied in the following period, thereby reducing power consumption.

A process in which the energy recovery circuit illustrated in the lower part of FIG. 11 applies an X electrode sustain pulse voltage to X electrodes in a sustain-discharge period will be described with reference to FIG. 12B (the process is applied in the same manner when a Y electrode sustain pulse voltage is applied to Y electrodes in the sustain-discharge period and when an address pulse voltage is applied to X electrodes in an address period).

In the lower part of FIG. 11, the energy recovery circuit denoted by an energy recovery unit includes a charge capacitor Cₑ, a rising period switching device Sᵣ, a rising period diode Dᵣ and a falling period diode D_{f} as current direction control diodes, a falling period switching device S_{f}, and a resonance inductor L.

FIG. 12B illustrates a driving voltage applied to the right terminal (corresponding to X electrodes) of the panel capacitor Cₚ of FIG. 11. As illustrated in FIG. 12B, a sustain pulse voltage applied to X electrodes in a sustain-discharge period includes a rising period, a first sustain period, a falling period, and a second sustain period.

In the rising period, since a sustain discharge voltage switching device Sₛ, a ground voltage switching device S_{g}, and the falling period switching device S_{f} are open and the rising period switching device Sᵣ is shorted, charge accumulated in the charge capacitor Cₑ in the previous period moves to the panel capacitor Cₚ via the rising period switching device Sᵣ, the rising period diode Dᵣ, and the resonance inductor L, so that a voltage applied to the right terminal of the panel capacitor Cₚ gradually rises.

In the first sustain period, since the ground voltage switching device S_{g}, the rising period switching device Sᵣ, and the falling period switching device S_{f} are open and the sustain discharge voltage switching device Sₛ is shorted, a sustain-discharge voltage Vₛ supplied from an external power source is applied to the right terminal of the panel capacitor Cₚ and maintained for a predetermined time.

In the falling period, since the sustain discharge voltage switching device Sₛ, the ground voltage switching device S_{g}, and the rising period switching device Sᵣ are open and the falling period switching device S_{f} is shorted, charge in the panel capacitor Cₚ moves to the charge capacitor Cₑ via the resonance inductor L, the falling period diode D_{f}, and the falling period switching device S_{f}, so that a voltage applied to the right terminal of the panel capacitor Cₚ gradually falls.

In the second sustain period, since the sustain-discharge voltage switching device Sₛ, the rising period switching device Sᵣ, and the falling period switching device S_{f} are open and the ground voltage switching device S_{g} is shorted, the ground voltage V_{g} is applied to the right terminal of the panel capacitor Cₚ and maintained for a predetermined time.

As such, by applying a pulse-shaped voltage as illustrated in FIG. 12B using an energy recovery circuit, instead of a discontinuously changing square pulse-shaped voltage (as illustrated in FIG. 12A), it is possible to reduce power consumption and the loads of the switching devices Sₛ and S_{g}.

Meanwhile, if the energy recovery circuit does not normally operate, ‘hard switching’ can occur at the ends of the rising period and falling period as illustrated in FIG. 12C. If the ‘hard switching’ frequently occurs, power consumption increases and the switching devices are damaged. Therefore, the energy recovery circuit must stably operate.

As such, when the quickly changing pulse-shaped voltage must be frequently applied, it is important that the energy recovery circuit normally operate.

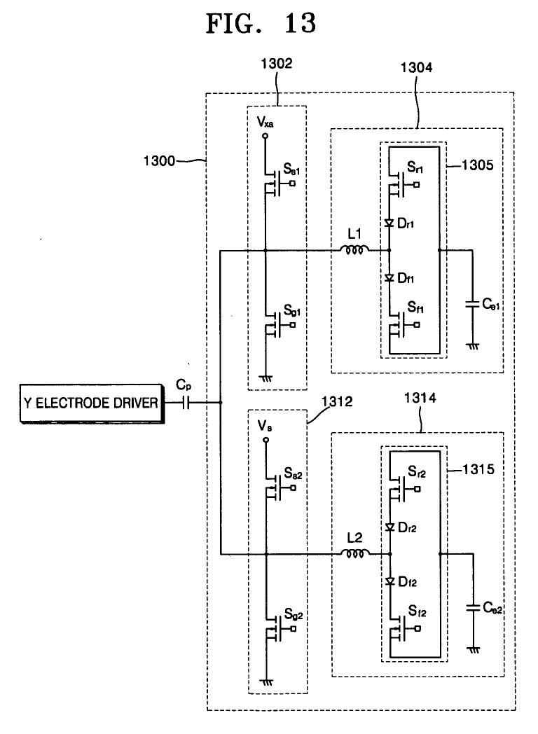

FIG. 13 is a circuit diagram of an X electrode driver 1300 of the 2-electrode type plasma display panel driving apparatus according to one embodiment.

Referring to FIG. 13, the X electrode driver 1300 includes an address pulse voltage supply unit 1302, a first energy recovery unit 1304, an X electrode sustain pulse voltage supply unit 1312, and a second energy recovery unit 1314.

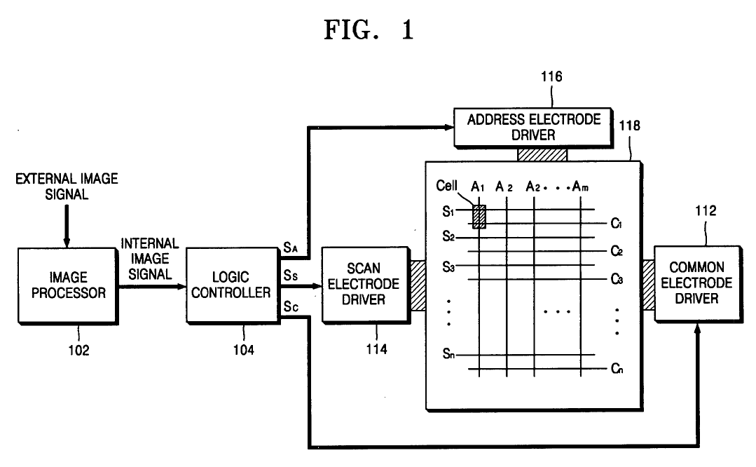

The X electrode driver 1300 (413 of FIG. 4) of the 2-electrode type plasma display panel driving apparatus may be similar to the address electrode driver 116 of the 3-electrode type plasma display panel driving apparatus of FIG. 1. Accordingly, the X electrode driver 1300 includes components (the X electrode sustain pulse voltage supply unit 1312 and the second energy recovery unit 1314) configured to apply an X electrode sustain pulse voltage to X electrodes, and includes components (the address pulse voltage supply unit 1302 and the first energy recovery unit 1304) configured to apply an address pulse voltage to the X electrodes, as illustrated in FIG. 13.

The X electrode driver 1300 operates the address pulse voltage supply unit 1302 and the first energy recovery unit 1304 and applies the address pulse voltage to X electrodes X₁ through Xₘ during an address period. Also, the X electrode driver 1300 operates the X electrode sustain pulse voltage supply unit 1312 and the second energy recovery unit 1314 and applies the X electrode sustain pulse voltage to the X electrodes X₁ through Xₘ during a sustain-discharge period.

Referring to FIGS. 9 and 13, the address pulse voltage supply unit 1302 supplies an address pulse voltage including an X electrode address voltage Vₓₐ having a high level and a ground voltage V_{g} having a low level.

The address pulse voltage supply unit 1302 includes a first high level switching device Sₛ₁ for supplying or blocking the high level voltage (the X electrode address voltage Vₓₐ) of the address pulse voltage and a first low level switching device S_{g1} for supplying or blocking the low level voltage (the ground voltage Vₐ) of the address pulse voltage.

The first energy recovery unit 1304 collects and accumulates charge from discharge cells in the address period and then provides the charged charge to the discharge cells.

The first energy recovery unit 1304 includes a first resonance inductor L1, a first charge capacitor Cₑ₁, and a first energy recovery controller 1305, as illustrated in FIG. 13.

The first energy recovery controller 1305 includes a first rising period switching device Sᵣ₁, a first falling period switching device S_{f1}, a first rising period diode Dᵣ₁, and a first falling period diode D_{f1}, and controls an operation in a falling period for accumulating charge collected from the discharge cells (corresponding to the panel capacitor Cₚ) in the first charge capacitor Cₑ₁ and an operation in a rising period for providing the charge accumulated in the first charge capacitor Cₑ₁ in the discharge cells. That is, in the falling period, the first falling period switching device S_{f1} is shorted so that charge collected from the discharge cells Cₚ is accumulated in the first charge capacitor Cₑ₁. In the rising period, the first rising period switching device Sᵣ₁ is shorted so that charge accumulated in the first charge capacitor Cₑ₁ is provided to the discharge cells.

As such, the first energy recovery unit 1304 moves charge accumulated in the first charge capacitor Cₑ₁ to the panel capacitor Cₚ in the rising period and moves the charges accumulated in the panel capacitor Cₚ in the falling period to the first charge capacitor Cₑ₁, using LC resonance between the panel capacitor Cp, the first resonance inductor L1, and the first charge capacitor Cₑ₁, thereby reducing power consumption when a driving voltage is applied.

The X electrode sustain pulse voltage supply unit 1312 supplies an X electrode sustain pulse voltage including a sustain discharge voltage Vₛ having a high level and a ground voltage V_{g} having a low level.

The X electrode sustain pulse voltage supply unit 1312 includes a second high level switching device Sₛ₂ for supplying or blocking the high level voltage (the sustain discharge voltage Vₛ) of the X electrode sustain pulse voltage, and a second low level switching device S_{g2} for supplying or blocking the low level voltage (the ground voltage V_{g}) of the X electrode sustain pulse voltage.

The second energy recovery unit 1314 accumulates charges from the discharge cells in the sustain-discharge period and then provides the accumulated charges to the discharge cells.

The second energy recovery unit 1314 includes a second resonance inductor L2, a second charge capacitor Cₑ₂, and a second energy recovery controller 1315, as illustrated in FIG. 13.

The second energy recovery controller 1315 includes a second rising period switching device Sᵣ₂, a second falling period switching device S_{f2}, a second rising period diode Dᵣ₂, and a second falling period diode D_{f2}, and controls an operation in the falling period of accumulating charge collected from the discharge cells (corresponding to the panel capacitor Cₚ) in the second charge capacitor Cₑ₂ and an operation in the rising period of providing charge accumulated in the second charge capacitor Cₑ₁ to the discharge cells Cₚ. That is, in the falling period, the second falling period switching device S_{f2} is shorted so that charge collected from the discharge cells Cₚ is accumulated in the second charge capacitor Cₑ₂, and in the rising period, the second rising period switching device Sr2 is shorted so that charge accumulated in the second charge capacitor Cₑ₂ is provided to the discharge cells Cₚ.

As such, the second energy recovery unit 1314 moves charge accumulated in the second charge capacitor Cₑ₂ to the panel capacitor Cₚ in the rising period and moves charge accumulated in the panel capacitor Cₚ to the second charge capacitor Cₑ₂ in the falling period, using LC resonance between the panel capacitor Cₚ, the second resonance inductor L2, and the second charge capacitor Cₑ₂, thereby reducing power consumption when a driving voltage is applied.

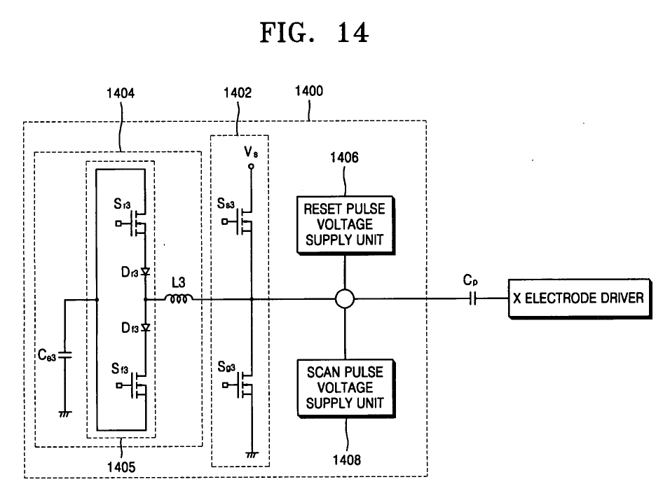

FIG. 14 is a circuit diagram of a Y electrode driver 1400 of the 2-electrode type plasma display panel driving apparatus according to one embodiment.

In FIG. 14, the Y electrode driver 1400 includes a Y electrode sustain pulse voltage supply unit 1402, a third energy recovery unit 1404, a reset pulse voltage supply unit 1406, and a scan pulse voltage supply unit 1408.

The Y electrode driver 1400 operates the reset pulse voltage supply unit 1406 to apply a ramp type reset pulse voltage to Y electrodes Y₁ through Yₙ in a reset period, operates the scan pulse voltage supply unit 1408 to apply a scan pulse voltage to the Y electrodes Y₁ through Yₙ in an address period, and operates the Y electrode sustain voltage supply unit 1402 and the third energy recovery unit 1404 in a sustain discharge period to apply the Y electrode sustain pulse voltage to the Y electrodes Y₁ through Yₙ.

Referring to FIGS. 9 and 14, the Y electrode sustain pulse voltage supply unit 1402 supplies a Y electrode sustain pulse voltage including a sustain discharge voltage Vₛ having a high level and a ground voltage V_{g} having a low level.

The Y electrode sustain pulse voltage supply unit 1402 includes a third high level switching device Sₛ₃ for supplying or blocking the high level voltage (the sustain discharge voltage Vₛ) of the Y electrode sustain pulse voltage, and a third low level switching device S_{g3} for supplying or blocking the low level voltage (the ground voltage V_{g}) of the Y electrode sustain pulse voltage.

The third energy recovery unit 1404 collects and accumulates charge from discharge cells in the sustain-discharge period and then provides the accumulated charge to the discharge cells.

The third energy recovery unit 1404 includes a third resonance inductor L3, a third charge capacitor Cₑ₃, and a third energy recovery controller 1405, as illustrated in FIG. 14.

The third energy recovery controller 1405 includes a third rising period switching device Sᵣ₃, a third falling period switching device S_{f3}, a third rising period diode Dᵣ₃, and a third falling period diode D_{f3}, and controls an operation in a falling period of accumulating charge collected from discharge cells (corresponding to a panel capacitor Cₚ) in the third charge capacitor Cₑ₃ and an operation in a rising period of providing charge accumulated in the third charge capacitor Cₑ₃ to the discharge cells. That is, in the falling period, the third falling period switching device S_{f3} is shorted so that charge collected from the discharge cells is accumulated in the third charge capacitor Cₑ₃, and in the rising period, the third rising period switching device Sᵣ₃ is shorted so that charge accumulated in the third charge capacitor Cₑ₃ is provided to the discharge cells.

As such, the third energy recovery unit 1404 moves charges accumulated in the third charge capacitor Cₑ₃ to the panel capacitor Cₚ in a rising period, and moves charges accumulated in the panel capacitor Cₚ to the third charge capacitor Cₑ₃ in a falling period, using LC resonance between the panel capacitor Cₚ, the third resonance inductor L3, and the third charge capacitor Cₑ₃, thereby reducing power consumption when a driving voltage is applied.

The reset pulse voltage supply unit 1406 supplies a ramp-shaped reset pulse voltage to Y electrodes in order to initialize all discharge cells in a reset period (see FIG. 9).

The scan pulse voltage supply unit 1408 supplies a scan pulse voltage to the Y electrodes in order to select discharge cells to be displayed in an address period (see FIG. 9).

Various embodiments reduce power consumption for circuits where a quickly changing pulse-shaped voltage is frequently applied to X electrodes or Y electrodes of a 2-electrode type plasma display panel (that is, when an address pulse voltage is applied to X electrodes, when an X electrode sustain pulse voltage is applied to X electrodes, and when an Y electrode sustain pulse voltage is applied to Y electrodes). In FIG. 14, the reset pulse voltage supply unit 1406 and the scan pulse voltage supply unit 1408 are simply represented by blocks.

Various electronic devices may be used as the switching devices in these embodiments. In FIGS. 13 and 14, the first high level switching device, the first low level switching device, the first falling period switching device, the first rising period switching device, the second high level switching device, the second low level switching device, the second falling period switching device, the second rising period switching device, the third high level switching device, the third low level switching device, the third falling period switching device, or the third rising period switching device is a field effect transistor (FET), but other switching devices may also be used.

As described above, because a 2-electrode type plasma display panel driving circuit includes an energy recovery circuit, a quickly changing pulse-shaped voltage can be stably applied.

While this description has been particularly shown and described with reference to exemplary embodiments thereof, it will be understood by those of ordinary skill in the art that various changes in form and details may be made without departing from the spirit and scope.

What is claimed is:

1. A plasma display panel driving apparatus configured to apply a driving voltage to a plasma display panel during a reset period, an address period, and a sustain-discharge period so as to drive the plasma display panel, the plasma display panel comprising a plurality of X electrodes extending in a first direction, a plurality of Y electrodes extending in a second direction perpendicular to the first direction, and discharge cells formed near locations where the X electrodes cross the Y electrodes, the apparatus comprising:
an X electrode driver configured to apply the driving voltage to the X electrodes;
a Y electrode driver configured to apply the driving voltage to the Y electrodes,
wherein the X electrode driver comprises:
an address pulse voltage supplying unit configured to supply an address pulse voltage to the X electrodes to select discharge cells to be displayed during the address period;
a first energy recovery unit configured to collect and store charge from discharge cells and to then provide the stored charge to the discharge cells, during the address period;
an X electrode sustain pulse voltage supplying unit configured to supply an X electrode sustain pulse voltage to the X electrodes in order to sustain-discharge selected discharge cells, during the sustain discharge period; and
a second energy recovery unit configured to collect and store charge from the discharge cells and to then provide the stored charge to the discharge cells, in the sustain-discharge period.

2. The plasma display panel driving apparatus of claim 1, wherein the X electrode driver is configured to operate the address pulse voltage supplying unit and the first energy recovery unit so as to apply the address pulse voltage to the X electrodes during the address period, and to operate the X electrode sustain pulse voltage supplying unit and the second energy recovery unit so as to apply the X electrode sustain pulse voltage to the X electrodes during the sustain-discharge period.

3. The plasma display panel driving apparatus of claim 1, wherein the address pulse voltage supplying unit comprises:
a first high level switching device configured to supply or to block a high level voltage of the address pulse voltage; and
a first low level switching device configured to supply or to block a low level voltage of the address pulse voltage.

4. The plasma display panel driving apparatus of claim 1, wherein the first energy recovery unit comprises:
a first resonance inductor causing LC resonance with a panel capacitance of the discharge cells;
a first charge capacitor configured to collect and store charge from the discharge cells; and
a first energy recovery controller configured during a falling period to control the storing of the charge collected from the discharge cells in the first charge capacitor, and during a rising period to control the providing of the stored charge to the discharge cells.

5. The plasma display panel driving apparatus of claim 4, wherein the first energy recovery controller comprises:
a first falling period switching device configured to be shorted during the falling period; a first falling period diode configured to control a direction of current during the falling period; a first rising period switching device configured to be shorted during the rising period; and a first rising period diode configured to control a direction of current during the rising period, wherein the first energy recovery controller is configured to configure the first falling period switching device to be shorted during the falling period so as to store the charge collected from the discharge cells in the first charge capacitor, and to configure the first rising period switching device to be shorted during the rising period so as to provide charge stored in the first charge capacitor to the discharge cells.

6. The plasma display panel driving apparatus of claim 1, wherein the X electrode sustain pulse voltage supply unit comprises:
a second high level switching device configured to supply or to block a high level voltage of the X electrode sustain pulse voltage; and
a second low level switching device configured to supply or to block a low level voltage of the X electrode sustain pulse voltage.

7. The plasma display panel driving apparatus of claim 1, wherein the second energy recovery unit comprises:
a second resonance inductor causing LC resonance with a panel capacitance of the discharge cells;
a second charge capacitor configured to collect and store charge from the discharge cells; and
a second energy recovery controller configured during a falling period to control the storing of the charge collected from the discharge cells in the second charge capacitor, and during a rising period to control the providing of the stored charge to the discharge cells.

8. The plasma display panel driving apparatus of claim 7, wherein the second energy recovery controller comprises:
a second falling period switching device configured to be shorted in during the falling period; a second falling period diode configured to control a direction of current during the falling period; a second rising period switching device configured to be shorted during the rising period; and a second rising period diode configured to control a direction of current during the rising period, and
wherein the second energy recovery controller is configured to configure the second falling period switching device to be shorted during the falling period so as to store the charge collected from the discharge cells in the second charge capacitor, and to configure the second rising period switching device to be shorted during the rising period so as to provide the charge stored in the second charge capacitor to the discharge cells.

9. The plasma display panel driving apparatus of claim 1, wherein the Y electrode driver comprises:
a Y electrode sustain pulse voltage supply unit configured to supply a Y electrode sustain pulse voltage to the Y electrodes in order to sustain or discharge selected discharge cells during the sustain-discharge period;
a third energy recovery unit configured to collect and store charge from the discharge cells and to provide the accumulated charge to the discharge cells during the sustain-discharge period;
a reset pulse voltage supply unit configured to supply a ramp-shaped reset pulse voltage to the Y electrodes in order to initialize the discharge cells during the reset period; and
a scan pulse voltage supply unit configured to supply a scan pulse voltage to the Y electrodes in order to select discharge cells to be displayed during the address period.

10. The plasma display panel driving apparatus of claim 9, wherein the Y electrode driver is configured to operate the reset pulse voltage supply unit during the reset period so as to apply the ramp-shaped reset pulse voltage to the Y electrodes, to operate the scan pulse voltage supply unit during the address period so as to apply the scan pulse voltage to the Y electrodes, and to operate the Y electrode sustain pulse voltage and the third energy recovery unit during the sustain-discharge period so as to apply the Y electrode sustain pulse voltage to the Y electrodes.

11. The plasma display panel driving apparatus of claim 9, wherein the Y electrode sustain pulse voltage supply unit comprises:
a third high level switching device configured to supply or to block a high level voltage of the Y electrode sustain pulse voltage; and
a third low level switching device configured to supply or to block a low level voltage of the Y electrode sustain pulse voltage.

12. The plasma display panel driving apparatus of claim 9, wherein the third energy recovery unit comprises:
a third resonance inductor causing LC resonance with a panel capacitance of the discharge cells;
a third charge capacitor configured to collect and store charge from the discharge cells;
a third energy recovery controller configured during a falling period to control the storing of the charge collected from the discharge cells in the third charge capacitor, and during a rising period to control the providing of the stored charge to the discharge cells.

13. The plasma display panel driving apparatus of claim 12, wherein the third energy recovery controller comprises:
a third falling period switching device configured to be shorted during the falling period; a third falling period diode configured to control a direction of current during the falling period; a third rising period switching device configured to be shorted during the rising period; and a third rising period diode configured to control a direction of current during the rising period,
wherein the third energy recovery controller is configured to configure the third falling period switching device to be shorted during the falling period so as to store the charge collected from the discharge cells in the third charge capacitor, and to configure the third rising period switching device to be shorted during the rising period so as to provide the charge stored in the third charge capacitor to the discharge cells.

14. A method of driving a plasma display panel, the plasma display panel comprising a plurality of X electrodes extending in a first direction, a plurality of Y electrodes extending in a second direction perpendicular to the first direction, and discharge cells formed near locations where the X electrodes cross the Y electrodes, the method comprising:
applying an address pulse voltage having a positive pulse-shaped waveform to the X electrodes and applying a scan pulse voltage with a negative pulse-shaped waveform to the Y electrodes, wherein discharge cells are selected to be displayed; and
applying an X electrode sustain pulse voltage alternately having a sustain-discharge voltage required for sustain-discharging and a ground voltage to the X electrodes, and applying a Y electrode sustain pulse voltage alternately having the ground voltage and the sustain-discharge voltage to the Y electrodes such that the Y electrode sustain pulse voltage has a polarity opposite of the X electrode sustain pulse voltage, wherein the selected discharge cells are sustain-discharged.

15. The method of claim 14, wherein the address pulse voltage is configured to be maintained at the ground voltage for a duration, maintained at an X electrode address voltage lower than the sustain-discharge voltage for another duration, and then maintained at the ground voltage.

16. The method of claim 14, wherein the scan pulse voltage is configured to be maintained at a first Y electrode address voltage lower than the sustain discharge voltage for a duration, maintained at a second Y electrode address voltage lower than the first Y electrode address voltage for another duration, and then maintained at the first Y electrode address voltage.

17. The method of claim 14, further comprising: applying the ground voltage to the X electrodes and applying a ramp-shaped reset pulse voltage to the Y electrodes, wherein the discharge cells are initialized, wherein the ramp-shaped reset pulse voltage has a rising ramp-shaped voltage rising from a first Y electrode reset voltage higher than the ground voltage to a second Y electrode reset voltage higher than the first Y electrode reset voltage, and a falling ramp-shaped voltage falling from the first Y electrode reset voltage to a third Y electrode reset voltage lower than the first Y electrode reset voltage.

18. A plasma display panel driving apparatus configured to apply a driving voltage to a plasma display panel during a reset period, an address period, and a sustain-discharge period so as to drive the plasma display panel, the plasma display panel comprising a plurality of X electrodes extending in a first direction, a plurality of Y electrodes extending in a second direction perpendicular to the first direction, and discharge cells formed near locations where the X electrodes cross the Y electrodes, the apparatus comprising:
an X electrode driver configured to apply the driving voltage to the X electrodes;
a Y electrode driver configured to apply the driving voltage to the Y electrodes,
wherein the X electrode driver comprises:
an address pulse voltage supplying unit configured to supply an address pulse voltage to the X electrodes to select discharge cells to be displayed during the address period; and
a first energy recovery unit configured to collect and store charge from discharge cells and to then provide the stored charge to the discharge cells, during the address period.

19. The plasma display panel driving apparatus of claim 18, wherein the X electrode driver is configured to operate the address pulse voltage supplying unit and the first energy recovery unit so as to apply the address pulse voltage to the X electrodes during the address period, and to operate the X electrode sustain pulse voltage supplying unit and the second energy recovery unit so as to apply the X electrode sustain pulse voltage to the X electrodes during the sustain-discharge period.

20. The plasma display panel driving apparatus of claim 18, wherein the address pulse voltage supplying unit comprises:
a first high level switching device configured to supply or to block a high level voltage of the address pulse voltage; and
a first low level switching device configured to supply or to block a low level voltage of the address pulse voltage.

21. The plasma display panel driving apparatus of claim 18, wherein the first energy recovery unit comprises:
a first resonance inductor causing LC resonance with a panel capacitance of the discharge cells;
a first charge capacitor configured to collect and store charge from the discharge cells; and
a first energy recovery controller configured during a falling period to control the storing of the charge collected from the discharge cells in the first charge capacitor, and during a rising period to control the providing of the stored charge to the discharge cells.
